(19) United States
(12) Patent Application Publication
(10) Pub. No.: US 2010/0332699 A1
(43) Pub. Date: Dec. 30, 2010

(54) COMPUTER READABLE MEDIUM AND INFORMATION PROCESSING APPARATUS

(75) Inventor: Kohei GENDA, Kawasaki-shi (JP)

Correspondence Address: SUGHRUE-265550, 2100 PENNSYLVANIA AVE. NW, WASHINGTON, DC, 20037-3213, US

(73) Assignee: FUJI XEROX CO., LTD., Tokyo (JP)

(21) Appl. No.: 12/634,127

(22) Filed: Dec. 9, 2009

(30) Foreign Application Priority Data
Jun. 25, 2009 (JP) 2009-151311

(51) Int. Cl. G06F 13/12

(52) U.S. Cl. 710/63

(57) ABSTRACT

A computer readable medium storing a program causing a computer to execute a process for managing peripheral devices, the process includes: acquiring a state of an apparatus when a peripheral device is connected to the apparatus; controlling the peripheral device to be available in a case where the acquired state of the apparatus is a first state, when a kind of the connected peripheral device is a first kind; and controlling the peripheral device to be available in a case where the acquired state of the apparatus is a second state, when the kind of the connected peripheral device is a second kind, in addition to when the kind of the connected peripheral device is the first kind.

### CROSS-REFERENCE TO RELATED APPLICATIONS

This application is based on and claims priority under 35 USC 119 from Japanese Patent Application No. 2009-151311 filed on Jun. 25, 2009.

### BACKGROUND

1. Technical Field

The present invention relates to a computer readable medium and an information processing apparatus.

2. Related Art

A USB (Universal Serial Bus) memory is compact, has a relatively large capacity, and is convenient to carry data. Therefore, a USB interface is laid open to general public users, and a print service via a USB memory is provided.

### SUMMARY

According to an aspect of the invention, a computer readable medium storing a program causing a computer to execute a process for managing peripheral devices, the process includes: acquiring a state of an apparatus when a peripheral device is connected to the apparatus; controlling the peripheral device to be available in a case where the acquired state of the apparatus is a first state, when a kind of the connected peripheral device is a first kind; and controlling the peripheral device to be available in a case where the acquired state of the apparatus is a second state, when the kind of the connected peripheral device is a second kind, in addition to when the kind of the connected peripheral device is the first kind.

### BRIEF DESCRIPTION OF THE DRAWINGS

Exemplary embodiments of the invention will be described in detail based on the following figures, wherein:

FIG. 1 is a block diagram schematically showing a configuration example of an information processing apparatus of a first embodiment of the invention;

FIG. 2 is a view showing an example of an allowed device list in the first embodiment;

FIG. 3 is a view showing an example of a mode management table in the first embodiment;

FIG. 4 is a view showing an example of a screen which is displayed on an operation displaying portion in a user mode;

FIG. 5 is a view showing an example of a screen which is displayed on the operation displaying portion in an administrator mode;

FIG. 6 is a flowchart showing an operation example of the information processing apparatus of the first embodiment;

FIG. 7 is a block diagram schematically showing a configuration example of an information processing apparatus of a second embodiment of the invention;

FIG. 8 is a flowchart showing an operation example in the case where a fault of the information processing apparatus of the second embodiment is detected;

FIG. 9 is a block diagram schematically showing a configuration example of an information processing apparatus of a third embodiment of the invention;

FIG. 10 is a view showing an example of an allowed device list in the third embodiment;

FIG. 11 is a view showing an example of a mode management table in the third embodiment; and

FIG. 12 is a flowchart showing an operation example in the case where a fault of the information processing apparatus of the third embodiment is detected.

### DETAILED DESCRIPTION

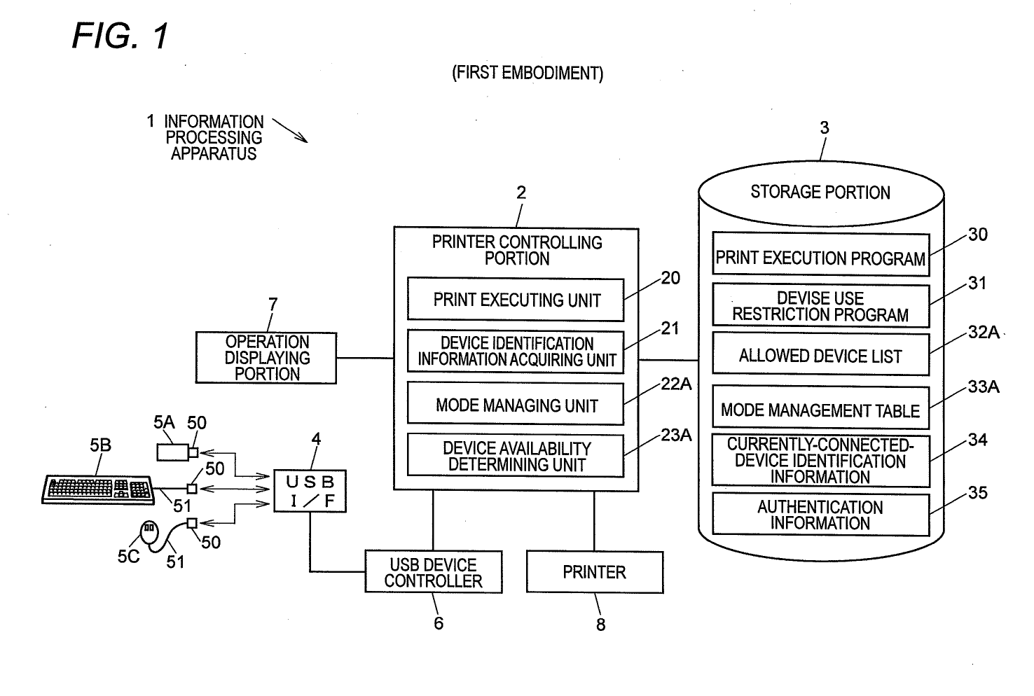

FIG. 1 is a block diagram schematically showing a configuration example of an information processing apparatus of a first embodiment of the invention. The information processing apparatus 1 has: a printer controlling portion 2 which controls a printer 8; a storage portion 3 which stores various programs and data; a USB interface (I/F) 4 to which various USB devices 5 (5A to 5C) that are examples of a peripheral device are to be connected; a USB device controller 6 which controls the USB devices 5 connected to the USB I/F 4; an operation displaying portion 7 which functions as a user interface; and a printer 8 which prints an image.

The information processing apparatus 1 may be a multi-functional apparatus which has further functions of a facsimile apparatus, a scanner, and the like, in addition to the above-mentioned function of a printer.

The storage portion 3 is configured by a ROM, a RAM, an HDD, and the like, and stores: programs such as a print execution program 30 for providing the user with a print service, and performing an adjusting work, and a devise use restriction program 31 for restricting the use of the USB devices 5; and data such as an allowed device list 32A configured by device identification information of USB devices 5 which are allowed to be used, a mode management table 33A indicating the current mode, device identification information 34 of a USB device 5 which is currently connected, and authentication information 35 configured by a password of the administrator and the like.

The printer controlling portion 2 is configured by a CPU, etc. The printer controlling portion 2 operates in accordance with the print execution program 30 to provide a print service, and function as a print executing unit 20 for performing adjusting operations, or, in accordance with the devise use restriction program 31, operates as: a device identification information acquiring unit 21 for acquiring device identification information from the USB device 5; a mode managing unit (an acquiring unit, a mode determining unit) 22A for, when a peripheral device is connected to the apparatus, acquiring the state of the apparatus, and determining whether the current mode (state of the apparatus) is a user mode or a non-user mode; and a device availability determining unit (controlling unit) 23A for determining availability of the USB device 5 in accordance with the apparatus state obtained by the mode managing unit 22A.

The term “user mode” means a mode in which mainly the user using the information processing apparatus 1 uses one of the USB devices 5, and “non-user mode” is an administrator mode in which mainly a person other than the user, for example, the administrator of the information processing apparatus 1 uses one of the USB devices 5. The term “administrator” means, for example, the manager of a shop where the information processing apparatus 1 is installed, and may include a maintenance person who maintains the information processing apparatus 1. In the user mode, the administrator may use one of the USB devices 5. The term “state of the apparatus” includes the mode, and a state where the information processing apparatus 1 requires maintenance.

In the case where the apparatus state obtained by the mode managing unit 22A is a first state, when the kind of a peripheral device connected to the USB I/F 4 is a first kind, the device availability determining unit 23A performs a control so that the peripheral device is available. In the case where the apparatus state obtained by the mode managing unit 22A is a second state, also when the kind of a peripheral device connected to the USB I/F 4 is a second kind, in addition to when the kind of the peripheral device connected to the USB I/F 4 is the first kind, the unit 23A performs a control so that the peripheral device is available. In this exemplary embodiment, the first state may mean “user mode” and the second state may mean “administration mode”. Also, a device of the first kind may mean a storage device, and a device of the second kind may mean a device to be used in maintenance of the information processing apparatus 1, for example, a mouse or a keyboard or the like. In other words, the device availability determining unit 23A changes the kind of a peripheral device the use of which is to be restricted, in accordance with the state of the information processing apparatus 1, and, in the state where the information processing apparatus 1 requires maintenance, changes the peripheral device kind so that the use restriction of a peripheral device is relaxed. Peripheral devices which are to be used in maintenance of the information processing apparatus 1 include those which relate to the operation of the information processing apparatus 1. Alternatively, in the state where the information processing apparatus 1 requires maintenance (the second state), the use restriction of a peripheral device may be canceled. The device availability determining unit 23A may also perform a control so that the device of the second kind is changed to be unavailable when the mode of the information processing apparatus 1 is changed from the second state to the first state.

The USB I/F 4 conforms to the USB standard. Although one USB I/F is disposed in the embodiment, two or more USB I/Fs may be disposed. The interface to which peripheral devices are to be connected may conform to an interface standard other than the USB standard, and may be either wired or wireless.

In the embodiment, as the USB devices 5, a USB memory 5A which is to be connected to the USB I/F 4 through a connector 50, and a keyboard 5B and mouse 5C which are to be connected to the USB I/F 4 through a connector 50 and a USB cable 51 are used. The USB devices 5 are not restricted to those described above, and may be a USB-DVD drive, a USB-CD drive, a digital camera, an electronic paper, etc. Alternatively, the USB devices may be a USB wireless mouse, USB wireless keyboard, and the like which are used in a wireless manner.

The operation displaying portion 7 is a touch panel display including: a liquid crystal display which functions as a displaying portion for displaying information, an image, and the like; and a touch panel which is overlappingly disposed on the front face of the liquid crystal display, and which functions as an inputting portion for receiving an input operation performed by the user. Alternatively, the inputting portion may be hardware keys configured by buttons which are not overlappingly disposed on the displaying portion, or software keys.

The print executing unit 20 of the printer controlling portion 2 controls the portions of the apparatus 1, and performs processes such as production of thumbnail images, expansion/contraction of an image, and edition of an image.

The printer 8 includes sheet trays which house print sheets of various sizes, and performs a printing process of printing an image recorded in the USB memory 5A, onto a print sheet.

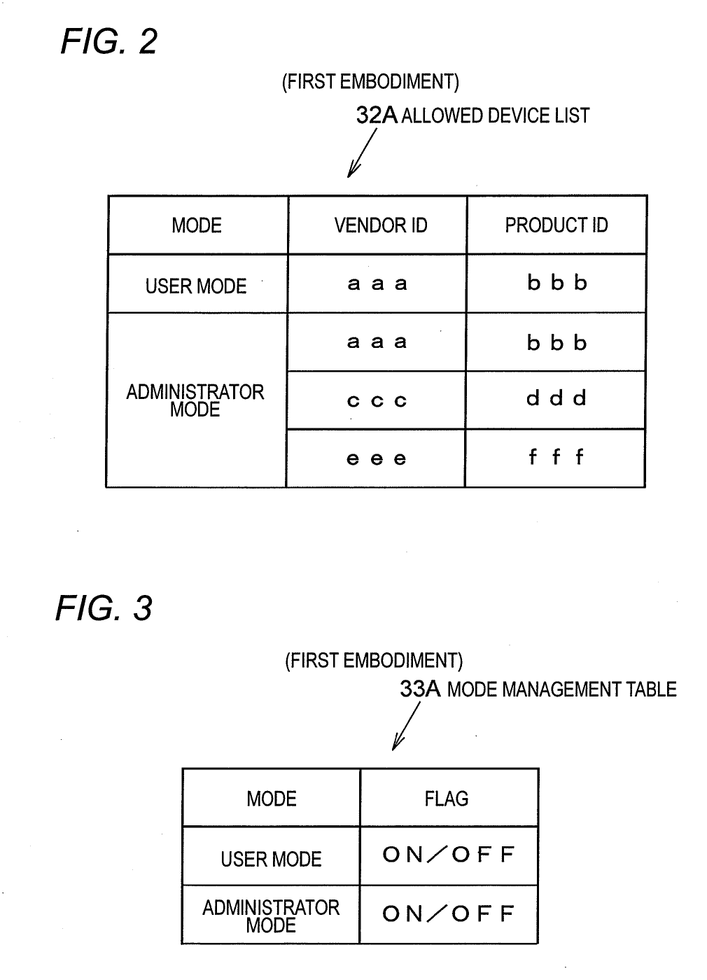

FIG. 2 shows an example of the allowed device list 32A. In the allowed device list 32A, for example, a vendor ID and a product ID are registered as the device identification information in accordance with the mode. The vendor ID is an ID for identifying a manufacturer, and the product ID is an ID for identifying the product specification. The device identification information may include a serial number which identifies the manufacturing number, a device class which identifies the kind of each USB device 5, a subclass which identifies a port protocol and the like of the USB device 5, etc. Alternatively, the device identification information may be configured by one of the above-described plural sets of device identification information, or a combination of two or more of the sets. The figures shows a case where, for the user mode, vendor ID “aaa” and product ID “bbb” are registered as the device identification information of the USB memory 5A, and, for the administrator mode, vendor ID “aaa” and product ID “bbb” are registered as the device identification information of the USB memory 5A, vendor ID “ccc” and product ID “ddd” are registered as the device identification information of the keyboard 5B, and vendor ID “eee” and product ID “fff” are registered as the device identification information of the mouse 5C.

FIG. 3 shows an example of the mode management table 33A. The mode management table 33A is used by the mode managing unit 22A, and configured so that the ON/OFF state of a flag can be set in accordance with the user mode and the administrator mode.

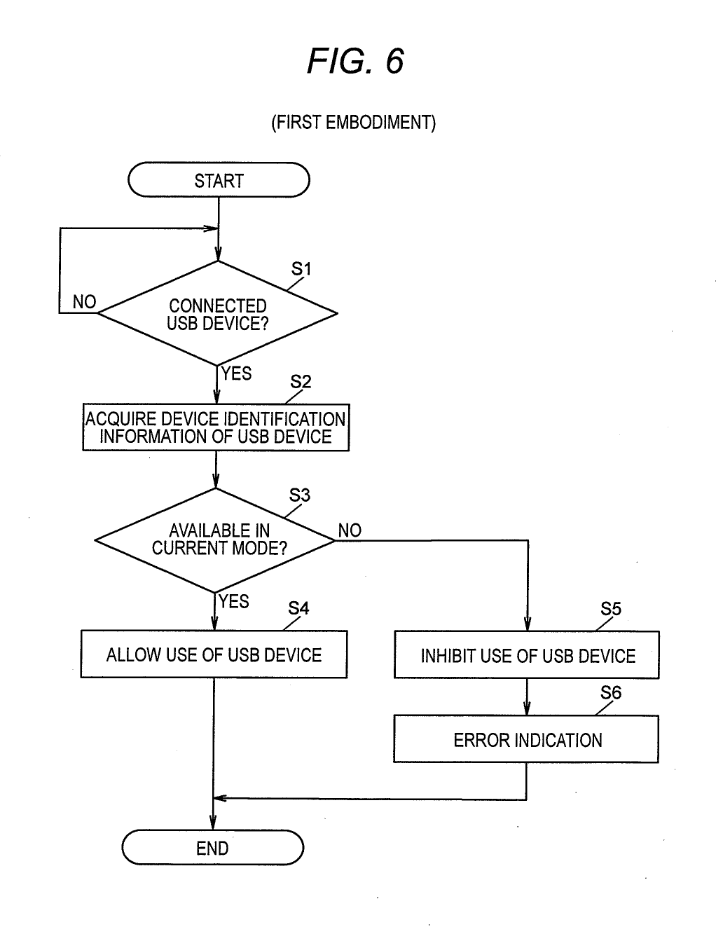

Next, an example of the operation of the information processing apparatus 1 will be described with reference to FIGS. 1 to 5 and in accordance with the flowchart shown in FIG. 6.

When the apparatus 1 is powered on, the printer controlling portion 2 performs the initializing process, and sets the mode to, for example, the user mode. Namely, the mode managing unit 22A sets the flag of the user mode of the mode management table 33A shown in FIG. 3 to ON, and the flag of the administrator mode to OFF.

In the user mode, when the administrator operates the operation displaying portion 7 to input a password allocated the administrator, thereby requesting the transition to the administrator mode, the mode managing unit 22A checks the input password against the authentication information 35 stored in the storage portion 3. If the input password matches one of passwords included in the authentication information 35, the mode managing unit 22A sets the flag of the user mode of the mode management table 33A to OFF, and the flag of the administrator mode to ON, so that the mode is transferred to the administrator mode.

In the administrator mode, when the administrator operates the operation displaying portion 7 to request the transition to the user mode, the mode managing unit 22A sets the flag of the user mode of the mode management table 33A to ON, and the flag of the administrator mode to OFF, so that the mode is transferred to the user mode. In the transition from the administrator mode to the user mode, the password of the administrator is not necessary.

When the user or the administrator connects one of the USB devices 5 to the USB I/F 4 (S1), the device identification information acquiring unit 21 of the printer controlling portion 2 acquires the device identification information configured by the vendor ID and the product ID, from the USB device 5, and stores the information into the storage portion 3 as currently-connected-device identification information (S2).

Referring to the flags of the mode management table 33A, the mode managing unit 22A determines whether the current mode is the user mode or the administrator mode, and notifies the device availability determining unit 23A of the determined current mode. The device availability determining unit 23A determines whether the USB device 5 connected to the USB I/F 4 is available in the current mode notified from the mode managing unit 22A or not (S3).

Namely, if the vendor ID and product ID which are the currently-connected-device identification information 34 stored in the storage portion 3 match those which are registered in the allowed device list 32A in correspondingly with the current mode, the device availability determining unit 23A determines that the USB device 5 connected to the USB I/F 4 is available in the current mode (S3: Yes). If not match, the unit determines that the USB device 5 connected to the USB I/F 4 is unavailable in the current mode (S3: No).

If it is determined in step S3 that the USB device is available (S3: Yes), the device availability determining unit 23A controls the USB device controller 6 so as to allow the use of the USB device 5 connected to the USB I/F 4 (S4).

When the current mode is the user mode and the USB device 5 is the USB memory 5A, for example, access to the USB memory 5A is enabled.

The print executing unit 20 reads out images from the USB memory 5A through the USB device controller 6, produces thumbnail images, and displays the thumbnail images on the operation displaying portion 7. The user presses with a finger on one of the thumbnail images displayed on the operation displaying portion 7, to select the image to be printed. The print executing unit 20 displays a screen for selecting the print size on the operation displaying portion 7.

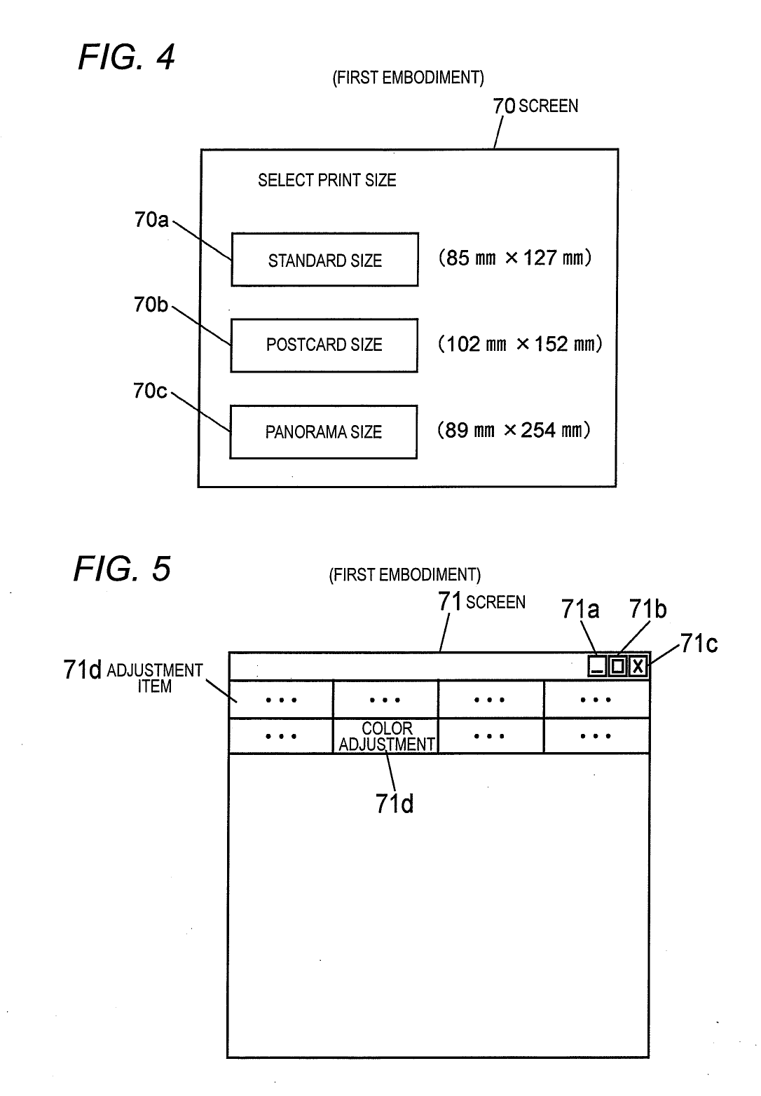

FIG. 4 shows an example of the screen displayed on the operation displaying portion 7 in the user mode. A screen 70 shown in the figure is a screen for selecting the print size, and displays “Standard size” button 70a, “Postcard size” button 70b, and “Panorama size” button 70c for selecting print sizes of 85 mm×127 mm, 102 mm×152 mm, and 89 mm×254 mm, respectively.

The user selects the print size by pressing with a finger on one of the three buttons 70a to 70c displayed on the screen 70 shown in FIG. 4. The print executing unit 20 controls the printer 8 so as to print the selected image on a print sheet of the print size which is selected by the user.

If the current mode is the administrator mode, the print executing unit 20 displays a screen which is necessary for managing the information processing apparatus 1, on the operation displaying portion 7.

FIG. 5 is a view showing an example of the screen which is displayed on the operation displaying portion 7 in the administrator mode. The screen 71 shown in FIG. 5 is a screen for selecting an adjustment item. In the screen 71, an icon configured by a minimize button 71a, a maximize button 71b, and a close button 71c is disposed in the right side of the uppermost portion, and a plurality (in the figure, eight) of adjustment items 71d are displayed below the icon. In the screen 71, the buttons 71a to 71c and the adjustment items 71d are smaller than the buttons 70a to 70c of the screen 70 shown in FIG. 4, and therefore hardly selected by a touch operation and are not adequate for inputting characters. Therefore, the use of the keyboard 5B or the mouse 5C is suitable for the selection.

The administrator connects the mouse 5C to the USB I/F 4, and then operates the mouse 5C to move the cursor to the position where the adjustment item 71d of “Color adjustment” is displayed, to select the item. Then, the print executing unit 20 displays a screen for color adjustment on the operation displaying portion 7. When the administrator operates the mouse 5C to move the cursor on the screen for color adjustment, the print executing unit 20 adjusts the color of the color image of the printer 8. The work of color adjustment is required, for example, in the case where a component is replaced with a new one because of a fault of the printer 8,

In the administrator mode, sometimes, the administrator connects the keyboard 5B to the USB I/F 4, and then inputs an IP address allocated to the information processing apparatus 1, a code, or the like by using the keyboard 5B. The input of an IP address is required, for example, in the case where a fault occurs in a network (not shown) to which the information processing apparatus 1 is connected.

If it is determined in step S3 that the USB device is unavailable (S3: No), the device availability determining unit 23A controls the USB device controller 6 so as to inhibit the use of the USB device 5 connected to the USB I/F 4 (S5). Specifically, even when the user or the administrator operates the USB device 5 connected to the USB I/F 4, for example, the USB device controller 6 is controlled so as not to accept the operation.

Next, the device availability determining unit 23A displays an error message on the operation displaying portion 7 (S6). For example, a message such as “Currently connected USB device cannot be used” is displayed.

According to the first embodiment, the kinds of the USB devices 5 which are available in the user mode are restricted as compared with the case of the administrator mode.

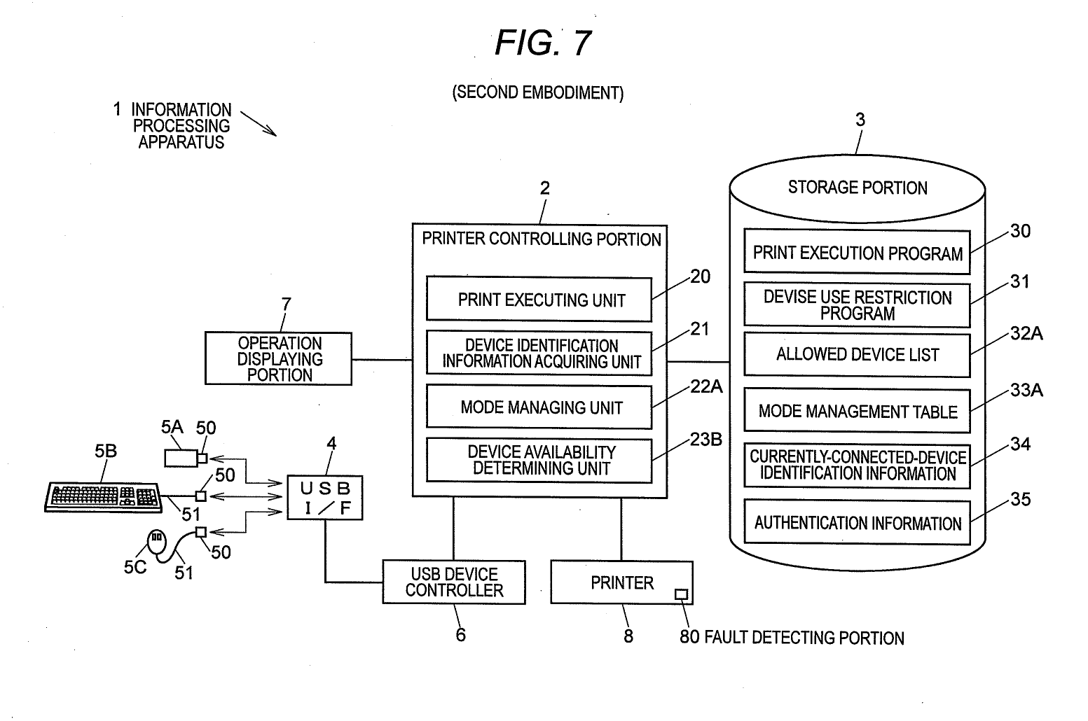

FIG. 7 is a block diagram schematically showing a configuration example of an information processing apparatus of a second embodiment of the invention. In the embodiment, the printer 8 includes a fault detecting portion 80 which detects an internal fault of the printer 8, and a device availability determining unit 23B is configured so that, when the fault detecting portion 80 detects a fault, the use restriction of the USB devices 5 is canceled. The other configuration is identical with that of the first embodiment.

As the fault detecting portion 80, for example, a sensor can be used which measures the temperature of a fixing device of the printer 8, and which, when the temperature of the fixing device fails to be within a predetermined temperature range, determines that a fault occurs (detects a fault).

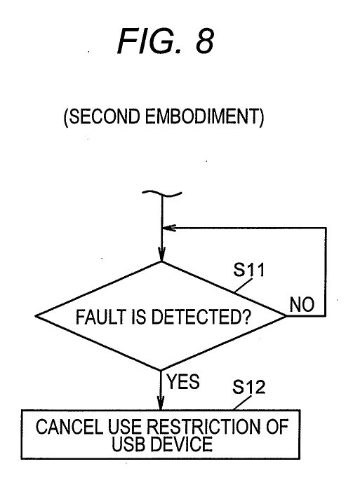

FIG. 8 is a flowchart showing an operation example of the information processing apparatus 1 of the second embodiment. As shown in FIG. 8, when the fault detecting portion 80 detects a fault of the printer 8 (S11), the fault detecting portion 80 transmits a fault detection signal to the printer controlling portion 2. The device availability determining unit 23B cancels the use restriction of the USB devices 5 (S12). Namely, the device availability determining unit 23B does not perform the determination of the availability of the USB devices 5 by using the allowed device list 32A, until the fault is repaired. Even when the user or the administrator operates any one of the USB devices 5, therefore, the USB device controller 6 accepts the operation. In the above, when a fault is detected, no availability determination is performed, and all kinds of USB devices are set to be available. Another configuration may be possible. When a fault is detected, for example, also USB devices relating to the operation of the information processing apparatus 1, i.e., devices for inputting information related to maintenance, such as the keyboard 5B and the mouse 5C may be determined to be available in the availability determination, thereby enabling the use of the USB devices. Alternatively, when a fault is detected, the mode may be automatically transferred to “administrator mode” described in the first embodiment, and the determination of the availability of the USB device 5 may be performed in the administrator mode.

According to the second embodiment, when a fault in the printer 8 is detected, the use restriction of the USB devices 5 is cancelled.

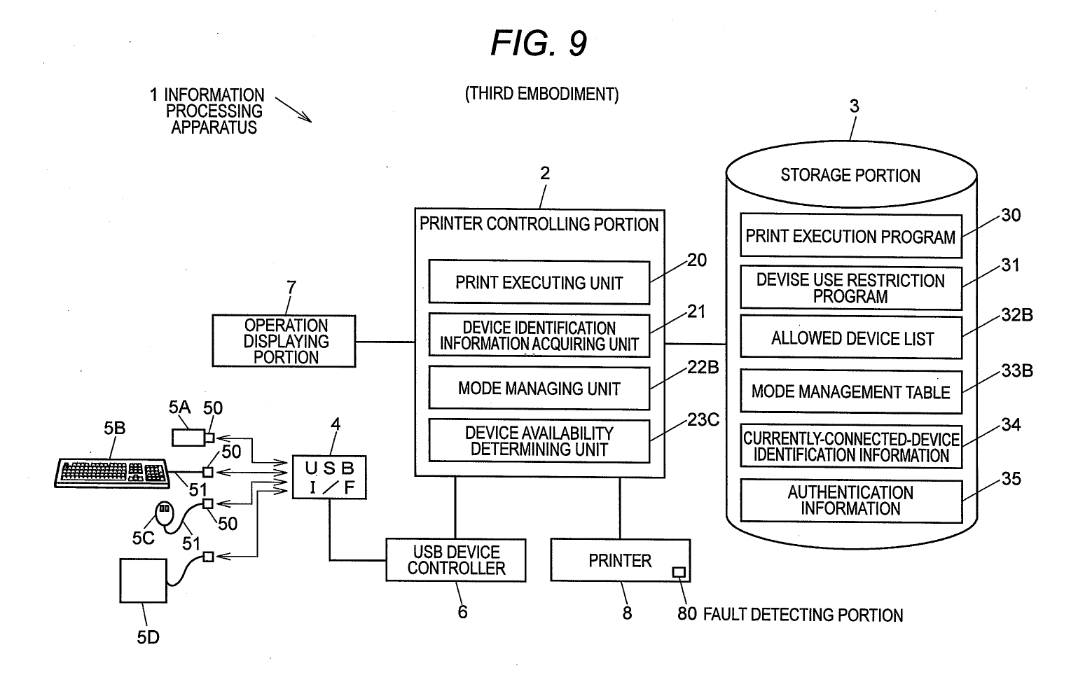

FIG. 9 is a block diagram schematically showing a configuration example of an information processing apparatus of a third embodiment of the invention. In the first and second embodiments, the two modes of the user mode and the administrator mode are used. In the embodiment, by contrast, a maintenance-person mode is used in addition to the two modes, and the printer 8 includes the fault detecting portion 80 which detects a fault of the printer 8. The other configuration is identical with that of the first embodiment.

An allowed device list 32B and a mode management table 33B are configured so as to correspond to the three modes.

A mode managing unit 22B manages the three modes on the basis of the mode management table 33B, and, when the fault detecting portion 80 detects a fault, transfers the mode to the maintenance-person mode.

A device availability determining unit 23C determines the availability of the USB devices 5 on the basis of the allowed device list 32B.

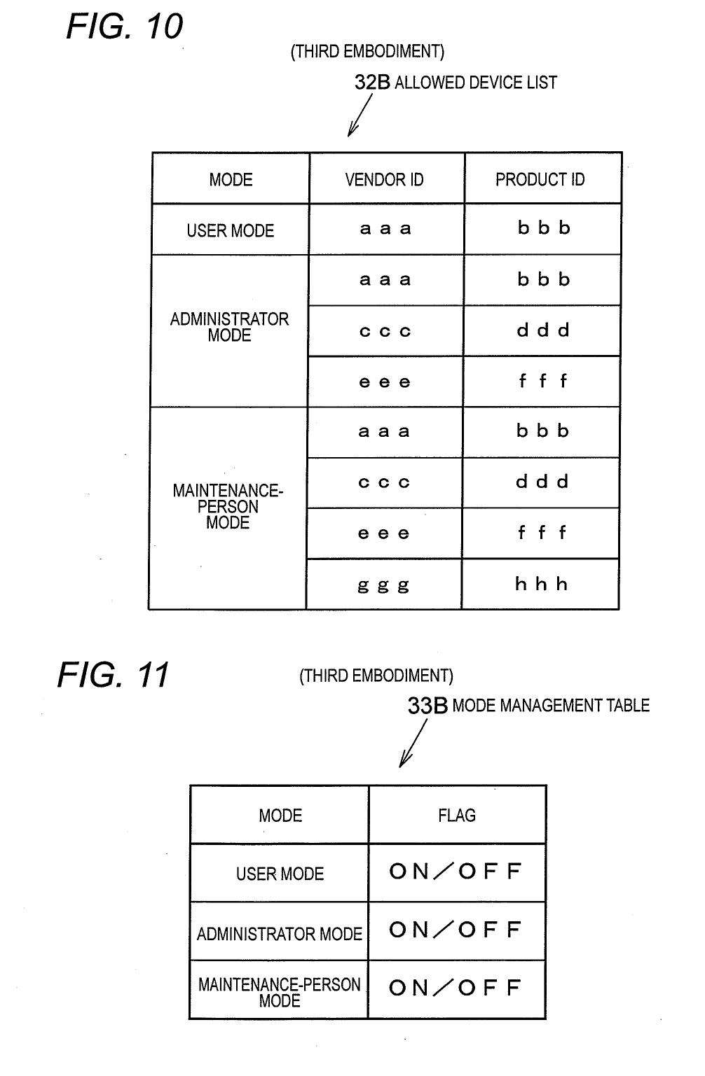

FIG. 10 shows an example of the allowed device list 32B. In the allowed device list 32B shown in FIG. 10, in a similar manner as the first embodiment, vendor ID “aaa” and product ID “bbb” of the USB memory 5A are registered as the device identification information in the user mode, a vendor ID and product ID of each of the USB memory 5A, the keyboard 5B, and the mouse 5C are registered as the device identification information in the administrator mode, and vendor ID “ggg” and product ID “hhh” of a USB-DVD drive 5D (an example of devices for outputting information related to maintenance) as a USB device having a USB connector are registered as the device identification information in the maintenance-person mode in addition to those of the USB memory 5A, the keyboard 5B, and the mouse 5C.

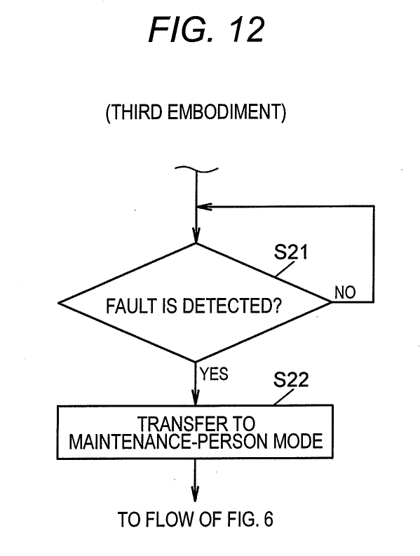

FIG. 11 shows an example of the mode management table 33B. The mode management table 33B is used by the mode managing unit 22B, and configured so that the ON/OFF state of a flag can be set in accordance with the user mode, the administrator mode, and the maintenance-person mode.

FIG. 12 is a flowchart showing an operation example of the information processing apparatus 1 of the third embodiment. As shown in FIG. 12, when the fault detecting portion 80 detects a fault of the printer 8 (S21), the fault detecting portion 80 transmits the fault detection signal to the printer controlling portion 2. The mode managing unit 22B of the printer controlling portion 2 sets the flags of the user and administrator modes of the mode management table 33B to OFF, and the flag of the maintenance-person mode to ON, so that the mode is transferred to the maintenance-person mode, and the device availability determining unit 23C is notified that the current mode is the maintenance-person mode (S22).

For example, the maintenance person connects the USB-DVD drive 5D to the USB I/F 4. The device availability determining unit 23C determines whether the USB-DVD drive 5D connected to the USB I/F 4 is available in the maintenance-person mode notified from the mode managing unit 22B or not. Namely, if the vendor ID and product ID which are the currently-connected-device identification information stored in the storage portion 3 match those which are registered in the allowed device list 32B in correspondingly with the maintenance-person mode, the device availability determining unit 23C determines that the USB-DVD drive 5D connected to the USB I/F 4 is available in the maintenance-person mode. If not match, the unit determines that the drive is unavailable.

If it is determined in step S3 that the USB-DVD drive 5D connected to the USB I/F 4 is available in the maintenance-person mode, the device availability determining unit 23C controls the USB device controller 6 so as to allow the use of the USB-DVD drive 5D.

When the user operates the operation displaying portion 7 to request that a log of faults and the like of the information processing apparatus 1 is to be recorded on a DVD-RAM by using the USB-DVD drive 5D, for example, the print executing unit 20 reads out the log stored in the storage portion 3, and controls the USB device controller 6 so as to write the log onto the DVD-RAM.

According to the third embodiment, when a fault occurs in the printer 8 in the user mode or the administrator mode, the mode is changed to the maintenance-person mode, and the use restriction of the USB device 5 is relaxed.

The invention is not restricted to the above-described embodiments, and may be variously modified without departing the spirit of the invention. Although, in the embodiments, the print executing unit, device identification information acquiring unit, mode managing unit, and device availability determining unit of the printer controlling portion are realized by the controlling portion and the programs, for example, a part or the whole of the units may be realized in hardware.

The programs which are used in the embodiments may be read from a recording medium such as a CD-ROM into the storage portion of the apparatus, or downloaded from a server or the like connected to a network such as the Internet into the storage portion of the apparatus.

Although, in the embodiments, the allowed device list for allowing the use of a USB device is used, an inhibited device list for inhibiting the use of a USB device may be used. In this case, when the device identification information of a USB device connected to the USB I/F is not registered in the inhibited device list, the device availability determining unit allows the use of the USB device, and, when registered in the inhibited device list, inhibits the use of the USB device.

In the embodiments, the allowed device list or the inhibited device list is prepared also for the administrator mode and the maintenance-person mode. Alternatively, for these modes, the allowed device list or the inhibited device list may be not prepared (not used), and the use of all kinds of USB devices may be allowed.

In the second and third embodiments, as the method of detecting a state where the information processing apparatus 1 requires maintenance, a fault of the printer 8 is detected. Alternatively, performance degradation, the life period, replacement timing of consumables, or the like of the information processing apparatus 1, a fault occurring in a network to which the information processing apparatus 1 is connected, or the like may be detected.

Although, in the embodiments, the image processing apparatus for processing an image has been described as the information processing apparatus, the invention may be applied also to an information processing apparatus for processing information including an image, such as a personal computer.

What is claimed is:

1. A computer readable medium storing a program causing a computer to execute a process for managing peripheral devices, the process comprising:
acquiring a state of an apparatus when a peripheral device is connected to the apparatus;
controlling the peripheral device to be available in a case where the acquired state of the apparatus is a first state, when a kind of the connected peripheral device is a first kind; and
controlling the peripheral device to be available in a case where the acquired state of the apparatus is a second state, when the kind of the connected peripheral device is a second kind, in addition to when the kind of the connected peripheral device is the first kind.

2. The computer readable medium according to claim 1, wherein the second state is a state where the apparatus requires a maintenance.

3. The computer readable medium according to claim 1, wherein the second kind is a kind of a peripheral device which is to be used for maintenance.

4. The computer readable medium according to claim 3, wherein the peripheral device which is to be used for maintenance is a device for inputting or outputting information related to maintenance of the apparatus.

5. The computer readable medium according to claim 1, the process further comprising:
controlling the peripheral device of the second kind, which has been available, to be unavailable when the state of the apparatus is changed from the first state to the second state.

6. An information processing apparatus comprising:
an acquiring unit that acquires a state of the apparatus when a peripheral device is connected to the apparatus; and
a controlling unit that performs a control to make the peripheral device available, (i) in a case where the state of the apparatus acquired by the acquiring unit is a first state, when a kind of the connected peripheral device is a first kind, and that performs a control to make the peripheral device available, (ii) in a case where the state of the apparatus acquired by the acquiring unit is a second state, when the kind of the connected peripheral device is a second kind, in addition to when the kind of the connected peripheral device is the first kind.
